(19) United States
(12) Patent Application Publication
(10) Pub. No.: US 2013/0016534 A1
(43) Pub. Date: Jan. 17, 2013

(54) RESONANT CONVERTER

(71) Applicants: Keita ISHIKURA, Saitama (JP); Shinji ASO, Saitama (JP)

(72) Inventors: Keita ISHIKURA, Saitama (JP); Shinji ASO, Saitama (JP)

(73) Assignee: SANKEN ELECTRIC CO., LTD., Saitama (JP)

(21) Appl. No.: 13/548,738

(22) Filed: Jul. 13, 2012

(30) Foreign Application Priority Data
Jul. 15, 2011 (JP) 2011-156319

(51) Int. Cl. H02M 3/335

(52) U.S. Cl. 363/21.02

(57) ABSTRACT

A resonant converter includes: a first switching element and a second switching element, which are connected in series; a series resonant circuit, which includes a primary coil of a transformer having leakage inductance and a current resonant capacitor, and which is connected in parallel to one of the first switching element and the second switching element; a rectifying-and-smoothing circuit, which is connected to a secondary coil of the transformer, wherein an output voltage is to be supplied to a load; and a clamp circuit, which clamps a voltage between both ends of the current resonant capacitor to a predetermined voltage value, wherein, when an output current supplied from the rectifying-and-smoothing circuit to the load is higher than the predetermined current value, an output characteristic is set so that, as the output current is increased, the output voltage is decreased.

### CROSS-REFERENCE TO RELATED APPLICATION

This application claims priority from Japanese Patent Application No. 2011-156319 filed on Jul. 15, 2011, the entire subject matter of which is incorporated herein by reference.

### TECHNICAL FIELD

This disclosure relates to a resonant converter, and more specifically, to an output characteristic of a resonant converter.

### BACKGROUND

Among resonant converters, a half-bridge type LLC (Line Level Control) resonant converter is known.

FIG. 10 shows a circuit diagram of a half-bridge type LLC resonant converter of the background art, and FIG. 11 shows an output characteristic of the half-bridge type LLC resonant converter of the background art. The half-bridge type LLC resonant converter of the background art includes a high-side switching element Q1 and a low-side switching element Q2, which are connected in series to each ends of a DC power source Vin. The switching elements Q1 and Q2 are MOSFETs, and have parasitic diodes (not illustrated) which are connected in parallel to be a reverse direction, respectively. Further, a series resonant circuit configured by a primary winding Np of a transformer T and a current resonant capacitor Cri is connected in parallel to the low-side switching element Q2. Incidentally, the primary winding Np of the transformer T has leakage inductance Lr and magnetization inductance. A secondary side of the transformer T is divided into two secondary windings NS1 and NS2 by an intermediate tap, and a rectifying-and-smoothing circuit is configured by diodes D10 and D11 and an output capacitor C10. That is, an anode of the diode D10 is not connected to the intermediate tap, but is connected to an end portion of the secondary winding NS1. An anode of the diode D11 is not connected to the intermediate tap, but is connected to an end portion of the secondary winding NS2. A positive terminal of the output capacitor C10 serves as a DC output terminal for outputting a DC output voltage Vo. Further, a negative terminal of the output capacitor C10 is connected to the intermediate tap between the secondary windings NS1 and NS2, and thus serves as a secondary ground terminal GND. (For example, refer to JP-A-2006-101683)

However, the half-bridge type LLC resonant converter of the background art is not suitable for uses of audio application. In the case where it is used as the audio application, a power supply device is needed to be driven with a wide load (load amount), and necessarily has appropriate load regulation (for example, refer to JP-A-2006-101683). Specifically, in the case of the increased load, it is necessary to lower the output voltage of the power supply device so as not to take electric power excessively, so that the load regulation should is to be large. In contrast, for the output characteristic of the half-bridge type LLC resonant converter of the background art, that is, the characteristic of output current Io and output voltage Vo, as indicated by reference numeral (X) in FIG. 11, even though the output current Io is changed, the output voltage Vo is less changed. Therefore, since the load regulation is small, the resonant converter is hard to be applied to the audio application.

With taking into consideration the background art, this disclosure provides at least a resonant converter capable of achieving a load regulation, which is suitable for an audio application.

### SUMMARY

A resonant converter of one aspect of this disclosure comprises: a first switching element and a second switching element, which are connected in series, and which are to be connected with a DC power source; a series resonant circuit, which includes a primary coil of a transformer having leakage inductance and a current resonant capacitor, and which is connected in parallel to one of the first switching element and the second switching element; a rectifying-and-smoothing circuit, which is connected to a secondary coil of the transformer, wherein an output voltage generated from the rectifying-and-smoothing circuit is to be supplied to a load by ON-OFF control of the first switching element and the second switching element; and a clamp circuit, which clamps a voltage between both ends of the current resonant capacitor to a predetermined voltage value, wherein, when an output current supplied from the rectifying-and-smoothing circuit to the load is higher than the predetermined current value, an output characteristic is set so that, as the output current is increased, the output voltage is decreased.

In addition to above-described resonant converter, the clamp circuit may include at least one of a first diode, which is connected between one end of the DC power source and one end of the current resonant capacitor, and a second diode, which is connected between the other end of the DC power source and the one end of the current resonant capacitor.

Above-described resonant converter may comprise a first capacitor, which is connected between the clamp circuit and the one end of the current resonant capacitor to adjust the output characteristic.

Above-described resonant converter may comprise a second capacitor, which is connected in series to the current resonant capacitor in the series resonant circuit to adjust the output characteristic.

Above-described resonant converter may comprise a first capacitor, which is connected between the clamp circuit and the one end of the current resonant capacitor; a second capacitor, which is connected in series to the current resonant capacitor in the series resonant circuit; and a third capacitor, which is connected in series to the DC power source via the current resonant capacitor, wherein the output characteristic is adjusted by the first capacitor, the second capacitor and the third capacitor.

A resonant converter of another aspect of this disclosure comprises: a first switching element and a second switching element, which are connected in series, and which are to be connected with a DC power source; a series resonant circuit, which includes a current resonant reactor, a primary coil of a transformer, and a current resonant capacitor, and which is connected in parallel to one of the first switching element and the second switching element, a rectifying-and-smoothing circuit, which is connected to a secondary coil of the transformer, wherein an output voltage generated from the rectifying-and-smoothing circuit is to be supplied to a load by ON-OFF control of the first switching element and the second switching element; and a clamp circuit which clamps a voltage between both ends of the current resonant capacitor to a predetermined voltage value, wherein, when an output current supplied from the rectifying-and-smoothing circuit to the load is higher than the predetermined current value, an output characteristic is set so that, as the output current is increased, the output voltage is decreased.

According to this disclosure, the resonant converter further includes the clamp circuit that clamps the voltage between both ends of the current resonant capacitor to the predetermined voltage value. Therefore, when the output current supplied from the rectifying-and-smoothing circuit to the load is higher than the predetermined current value, the output characteristic is set so that, as the output current is increased, the output voltage is decreased, thereby achieving an load regulation, which is suitable for an audio application.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a circuit diagram illustrating a circuit configuration of a resonant converter according to a first embodiment of this disclosure;

FIG. 2 is an operational waveform chart illustrating each section of the resonant converter illustrated in FIG. 1;

FIG. 3 is a graph illustrating an output characteristic of the resonant converter illustrated in FIG. 1;

FIGS. 4A and 4B are circuit diagrams illustrating a modification of the resonant converter according to the first embodiment of this disclosure;

FIG. 5 is a circuit diagram illustrating a circuit configuration of a resonant converter according to a second embodiment of this disclosure;

FIG. 6 is a graph illustrating an output characteristic of the resonant converter illustrated in FIG. 5;

FIG. 7 is a circuit diagram illustrating a circuit configuration of a resonant converter according to a third embodiment of this disclosure;

FIG. 8 is a graph illustrating an output characteristic of the resonant converter illustrated in FIG. 7;

FIG. 9 is a circuit diagram illustrating a modification of the resonant converter according to the second and third embodiments of this disclosure;

FIG. 10 is a circuit diagram illustrating a circuit configuration of a resonant converter of the background art; and

FIG. 11 is a graph illustrating an output characteristic of the resonant converter of the background art.

### DETAILED DESCRIPTION

Embodiments of this disclosure will be described in detail with reference to the accompanying drawings.

### First Embodiment

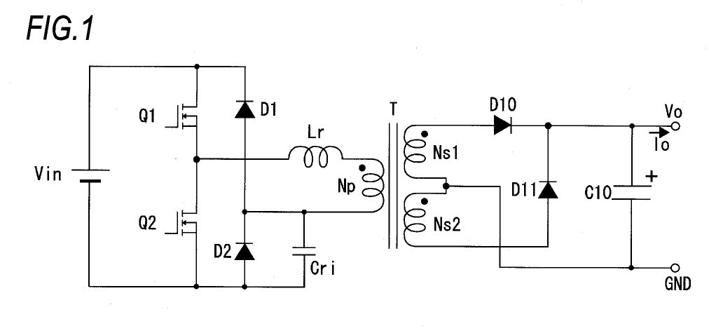

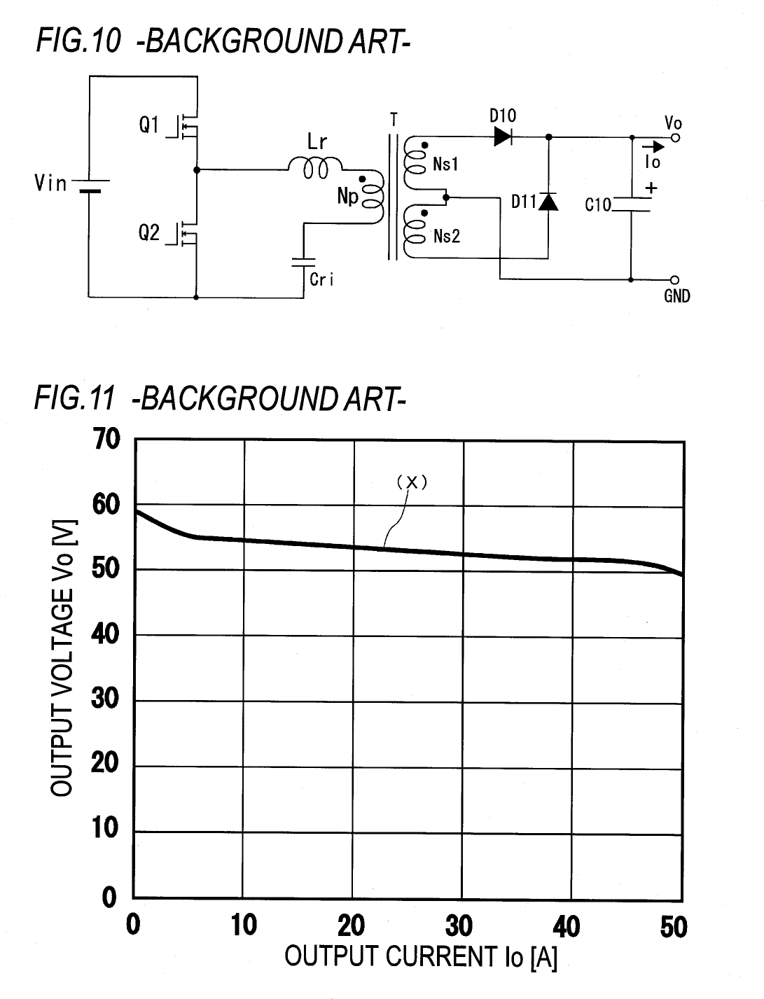

In addition to a circuit configuration of the half-bridge type LLC resonant converter of the background art illustrated in FIG. 10, a resonant converter according to the first embodiment, as described in FIG. 1, includes a clamp circuit that clamps a voltage V_{Cri} between both ends of a current resonant capacitor Cri to a predetermined voltage value.

Referring to FIG. 1, the clamp circuit includes a diode D1 (first diode) and a diode D2 (second diode). The diode D1 is connected in a reverse direction between a drain electrode of a high-side switching element Q1 and a connection point of a primary winding Np and the current resonant capacitor Cri. That is, a cathode of the diode D1 is connected to the drain electrode of the high-side switching element Q1, and an anode of the diode D1 is connected to the connection point between the primary winding Np and the current resonant capacitor Cri.

The diode D2 is connected in a reverse direction between both ends of the current resonant capacitor Cri. That is, a cathode of the diode D2 is connected to the primary winding Np and a connection point of the current resonant capacitor Cri and the anode of the diode D1, and an anode of the diode D2 is connected to a connection point of a source electrode of a low-side switching element Q2 (second switching element) and the current resonant capacitor Cri.

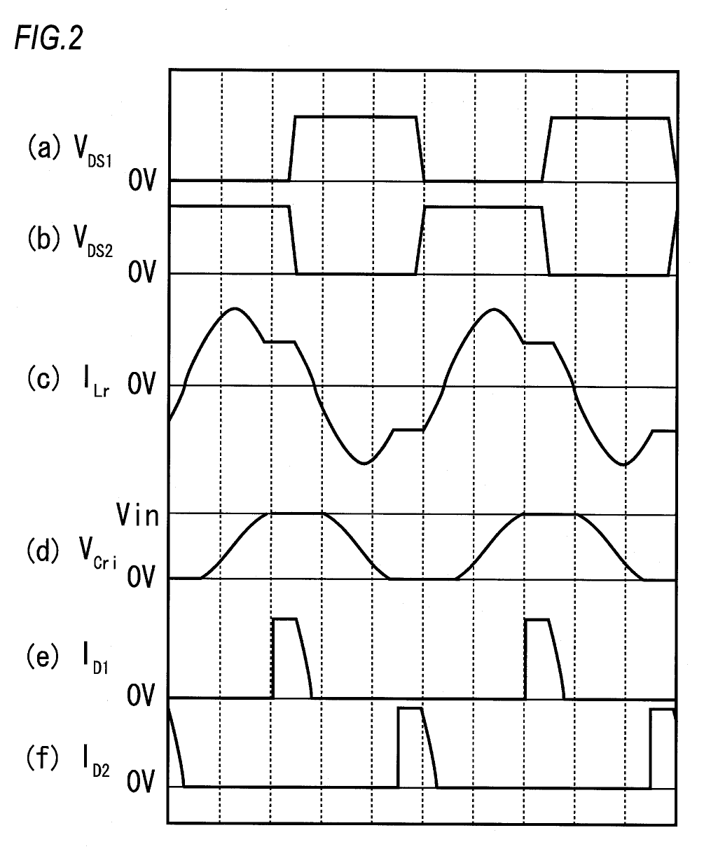

FIG. 2 is an operational waveform chart illustrating each section of the resonant converter illustrated in FIG. 1. A part (a) of FIG. 2 illustrates a voltage V_{DS1} between the drain electrode and the source electrode of the switching element Q1, a part (b) of FIG. 2 illustrates a voltage V_{DS2} between the drain electrode and the source electrode of the switching element Q2, a part (c) of FIG. 2 illustrates a current I_{Lr} flowing from the connection point between the switching elements Q1 and Q2 to the primary side of the transformer T, a part (d) of FIG. 2 illustrates a voltage V_{Cri} between both ends of the current resonant capacitor Cri, a part (e) of FIG. 2 illustrates a current I_{D1} flowing in the diode D1, and a part (f) of FIG. 2 illustrates a current I_{D2} flowing in the diode D2. (Herein after the part (a) of FIG. 2 is also referred as FIG. 2(a). other parts is also referred in same manner.)

If the resonant converter of the first embodiment is operated at a constant switching frequency and the switching element Q1 is ON, as illustrated in FIG. 2(d), the voltage between both ends of the current resonant capacitor Cri is increased. Then, if the voltage reaches the voltage Vin of the DC power source Vin, as illustrated in FIG. 2(e), the diode D1 is electrically conducted, and the voltage V_{Cri} between both ends of the current resonant capacitor Cri is clamped to the voltage Vin. Further, when the switching element Q2 is ON, as illustrated in FIG. 2(d), the voltage V_{Cri} between both ends of the current resonant capacitor Cri is lowered. Then, if the voltage reaches zero voltage, as illustrated in FIG. 2(f), the diode D2 is electrically conducted, the voltage V_{Cri} between both ends of the current resonant capacitor Cri is clamped to zero voltage.

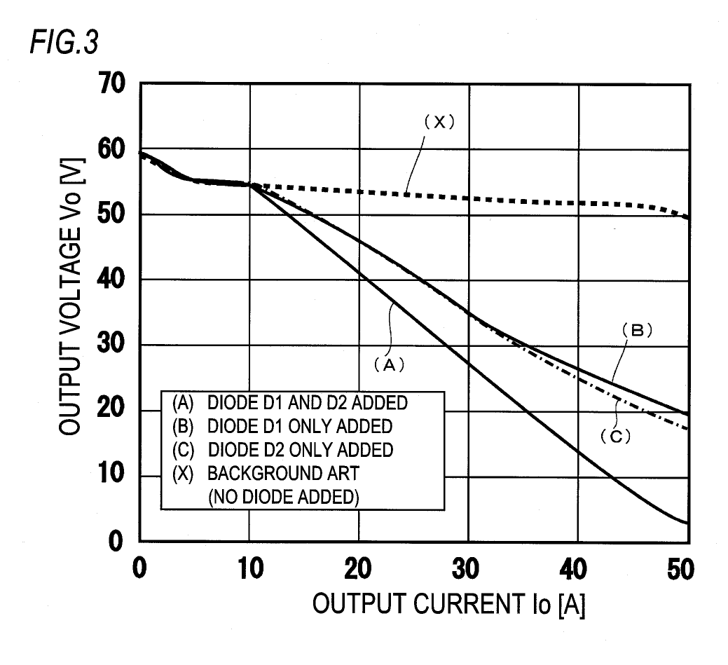

As described above, since the voltage V_{Cri} between both ends of the current resonant capacitor Cri is clamped to the zero voltage, as illustrated by a line (A) in FIG. 3, when the output current Io is a predetermined value (for example, 10A) or more, the output voltage Vo is to be decreased. As a result, the load regulation becomes large, as compared to the background art indicated by a line (X) in FIG. 3.

As described above, the first embodiment is configured so that the voltage V_{Cri} between both ends of the current resonant capacitor Cri is clamped to the voltage Vin by the diode D1 and also the voltage V_{Cri} between both ends of the current resonant capacitor Cri is clamped to the zero voltage by the diode D2. When the output current Io is the predetermined or more, the output voltage Vo can be lowered, thereby effectively obtaining the load regulation suitable for an audio application.

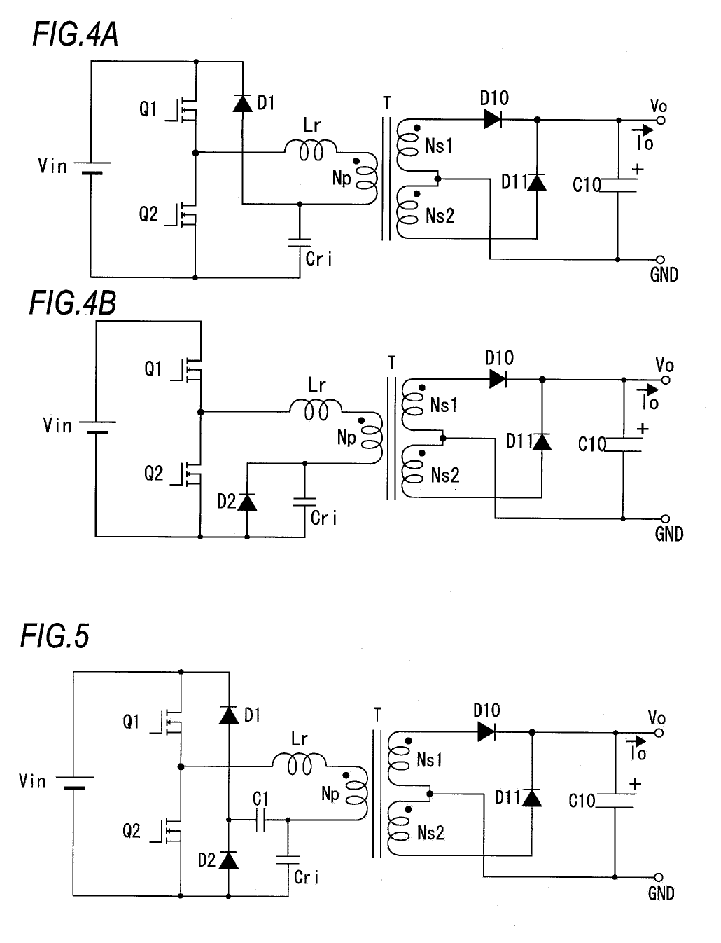

Additionally, although both of the diode D1 and the diode D2 are provided as the clamp circuit in the first embodiment, only the diode D1 may be provided as the clamp circuit, as illustrated in FIG. 4A, so that the voltage V_{Cri} between both ends of the current resonant capacitor Cri can be clamped to the voltage Vin only. Otherwise, only the diode D2 may be provided as the clamp circuit, as illustrated in FIG. 4B, so that the voltage V_{Cri} between both ends of the current resonant capacitor Cri can be clamped to the zero voltage only. In the case where any one of the diodes D1 and D2 is provided, as illustrated in lines (B) and (C) in FIG. 3, if the output current Io becomes 10A or more, the output voltage Vo is to be decreased, so that the load regulation becomes large. Meanwhile, as illustrated in FIG. 3, in the case where any one of the diodes D1 and D2 is provided, as illustrated in FIG. 3, the load regulation becomes small, as compared to the case where both the diode D1 and the diode D2 are provided. Accordingly, depending on the intended output characteristic, it can be determined whether both the diode D1 and the diode D2 are provided or any one of the diodes D1 and D2 is provided.

### Second Embodiment

In addition to the configuration of the resonant converter of the first embodiment, a resonant converter of the second embodiment, as illustrated in FIG. 5, further includes an output characteristic adjustment capacitor C1 (first capacitor) which is connected between the connection point of the anode of the diode D1 and the cathode of the diode D2, and the connection point of the primary winding Np and the current resonant capacitor Cri.

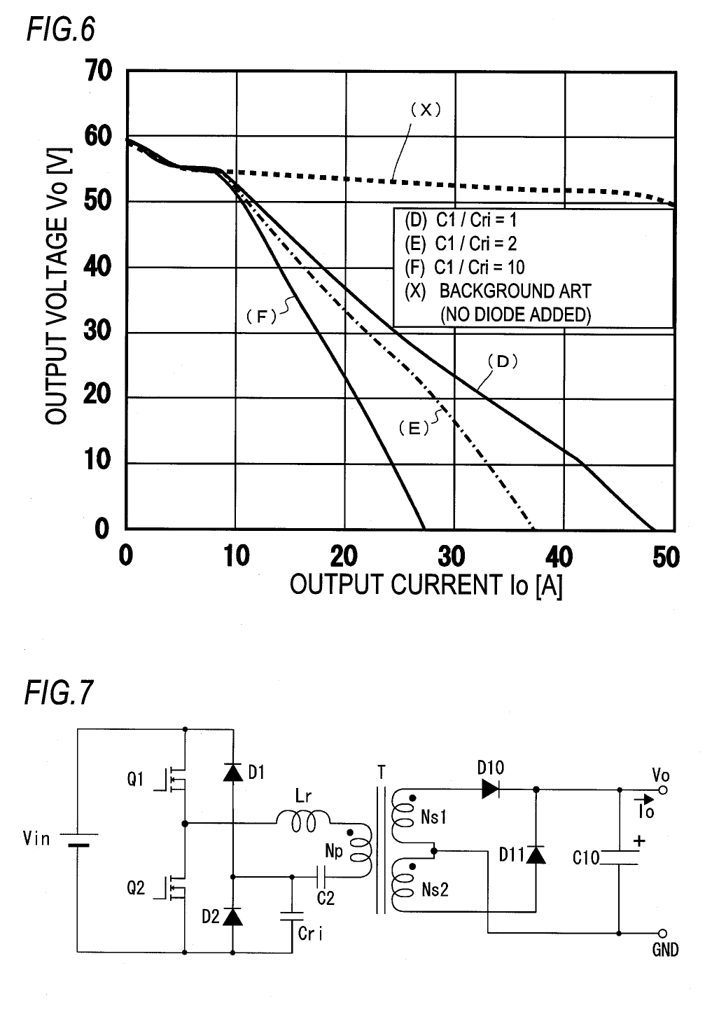

In the resonant converter of the second embodiment, the voltage V_{Cri} between both ends of the current resonant capacitor Cri is clamped by the diodes D1 and D2 configuring the clamp circuit via the output characteristic adjustment capacitor C1. That is, when the voltage V_{Cri} between both ends of the output characteristic adjustment capacitor C1 and the current resonant capacitor Cri, which are connected in series to each other, is increased and reaches the voltage Vin, the diode D1 is electrically conducted and then a composite voltage of the output characteristic adjustment capacitor C1 and the current resonant capacitor Cri, which are connected in series to each other, is clamped to the voltage Vin. In addition, when the voltage V_{Cri} between both ends of the output characteristic adjustment capacitor C1 and the current resonant capacitor Cri which are connected in series to each other is decreased and reaches the zero voltage, the diode D2 is electrically conducted. The voltage V_{Cri} between both ends of the output characteristic adjustment capacitor C1 and the current resonant capacitor Cri which are connected in series to each other is clamped to the zero voltage. Accordingly, in addition to the operation achieved by the first embodiment, the output characteristic (output current-output voltage characteristic) can be changed based on a ratio between the capacity of the output characteristic adjustment capacitor C1 and the capacity of the current resonant capacitor Cri. That is, the output characteristic is changed by changing the ratio between the capacity of the output characteristic adjustment capacitor C1 and the capacity of the current resonant capacitor Cri, as indicated by reference lines (D) to (F) in FIG. 6. In FIG. 6, the line (D) denotes an example in which C1/Cri is set by one times, the line (E) denotes an example in which C1/Cri is set by two times, and the line (F) denotes an example in which C1/Cri is set by ten times. It would be understood that, as the ratio between the capacity of the output characteristic adjustment capacitor C1 and the capacity of the current resonant capacitor Cri is increased, the load regulation becomes large.

As described above, the second embodiment includes the output characteristic adjustment capacitor C1 which is connected at one end thereof between the connection point of the primary winding Np of the transformer T and the current resonant capacitor Cri. Also, the composite voltage of the output characteristic adjustment capacitor C1 and the current resonant capacitor Cri, which are connected in series to each other, is clamped to the voltage Vin by the diode D1, and the voltage V_{Cri} between both ends of the output characteristic adjustment capacitor C1 and the current resonant capacitor Cri, which are connected in series to each other, is clamped to the zero voltage by the diode D2. Therefore, in addition to the effect achieved by the first embodiment, any output characteristic can be obtained by varying the capacities of the output characteristic adjustment capacitor C1 and the current resonant capacitor Cri, so that the load regulation suitable for the audio application is achieved.

### Third Embodiment

In addition to the configuration of the resonant converter of the first embodiment, a resonant converter of the third embodiment, as described in FIG. 7, further includes a output characteristic adjustment capacitor C2 (second capacitor) which is connected between the primary winding Np of the transformer T and the current resonant capacitor Cri. The connection point of the current resonant capacitor Cri and the output characteristic adjustment capacitor C2 is connected to the connection point of the anode of the diode D1 and a cathode of the output characteristic adjustment diode D2.

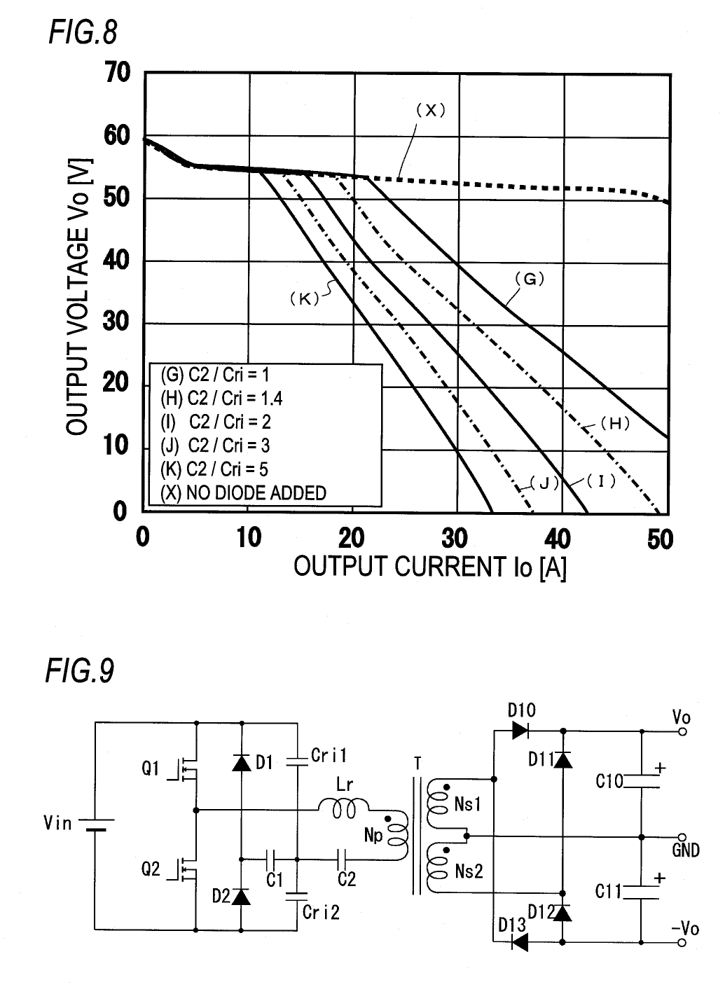

According to the resonant converter of the third embodiment, the output characteristic adjustment capacitor C2 is inserted in the series resonant circuit configured by the primary winding Np of the transformer T and the current resonant capacitor Cri, and the voltage V_{Cri} between both ends of current resonant capacitor Cri is clamped by the diodes D1 and D2 configuring the clamp circuit. Accordingly, the output characteristic can be changed based on a ratio between the capacity of the output characteristic adjustment capacitor C2 and the capacity of the current resonant capacitor Cri. That is, the output characteristic is changed by changing the ratio between the capacity of the output characteristic adjustment capacitor C2, which is inserted in the series resonant circuit, and the capacity of the current resonant capacitor Cri, as indicated by lines (G) to (K) in FIG. 8.

As described above, the third embodiment includes the output characteristic adjustment capacitor C2, which is connected between the primary winding Np of the transformer T and the current resonant capacitor Cri. Therefore, in addition to the effect achieved by the first embodiment, any output characteristic can be obtained by varying the capacities of the output characteristic adjustment capacitor C2 and the current resonant capacitor Cri, thereby achieving the effect of obtaining the load regulation suitable for the audio application.

Meanwhile, both the output characteristic adjustment capacitors C1 and C2 may be provided by combining the second and third embodiments.

In addition, as illustrated in FIG. 9, the current resonant capacitor Cri may be divided into two parts, that is, Cri1 and Cri2 (third capacitor) to separate it to positive and negative voltage Vin.

Although an example of employing a full-wave rectification circuit as a secondary rectification manner is described in this embodiment, for example, a half-wave rectification circuit or a bridge rectification circuit may be employed. FIG. 9 illustrates an example of a positive-negative power source circuit by a voltage-doubler full-wave rectification circuit, in which diodes D12 and D13 and a capacitor C11 is newly provided, as a secondary rectification manner.

Although the series resonant circuit is configured to be connected in series to the low-side switching element Q2 in this embodiment, the series resonant circuit may be configured to be connected to in parallel to the high-side switching element Q1.

Also, in this embodiment, the transformer T is a loosely-coupled transformer (leakage flux transformer), and Lr in FIG. 1 is the inductance (leakage inductance) which is formed integrally with the primary coil of the loosely-coupled transformer. However, a tightly-coupled transformer may be used as the transformer T. In this instance, Lr in FIG. 1 needs to utilize an independent inductance (current resonant reactor), but not a transformer integrated inductance.

Although the clamp circuit that clamps the voltage V_{Cri} between both ends of the current resonant capacitor Cri to the voltage Vin or zero voltage is provided in this embodiment, a clamp circuit that clamps the voltage to other voltage supply source, which is different from the DC power source Vin, may be provided.

It will be apparent that this disclosure is not limited to the above embodiments, but each embodiment can be appropriately modified or changed without departing from the scope of this disclosure. Further, the number, the position, the shape, or the like of the constitutional components is not limited to that of the embodiments, and any number, a position, a shape, or the like suitable for carrying out this disclosure can be selected. In this disclosure, a similar component in respective embodiments is referred by the similar symbol.

What is claimed is:

1. A resonant converter comprising:
a first switching element and a second switching element, which are connected in series, and which are to be connected with a DC power source;
a series resonant circuit, which includes a primary coil of a transformer having leakage inductance and a current resonant capacitor, and which is connected in parallel to one of the first switching element and the second switching element;
a rectifying-and-smoothing circuit, which is connected to a secondary coil of the transformer, wherein an output voltage generated from the rectifying-and-smoothing circuit is to be supplied to a load by ON-OFF control of the first switching element and the second switching element; and
a clamp circuit, which clamps a voltage between both ends of the current resonant capacitor to a predetermined voltage value,
wherein, when an output current supplied from the rectifying-and-smoothing circuit to the load is higher than the predetermined current value, an output characteristic is set so that, as the output current is increased, the output voltage is decreased.

2. The resonant converter according to claim 1,
wherein the clamp circuit includes at least one of a first diode, which is connected between one end of the DC power source and one end of the current resonant capacitor, and a second diode, which is connected between the other end of the DC power source and the one end of the current resonant capacitor.

3. The resonant converter according to claim 2, further comprising
a first capacitor, which is connected between the clamp circuit and the one end of the current resonant capacitor to adjust the output characteristic.

4. The resonant converter according to claim 2, further comprising
a second capacitor, which is connected in series to the current resonant capacitor in the series resonant circuit to adjust the output characteristic.

5. The resonant converter according to claim 2, further comprising:
a first capacitor, which is connected between the clamp circuit and the one end of the current resonant capacitor;
a second capacitor, which is connected in series to the current resonant capacitor in the series resonant circuit; and
a third capacitor, which is connected in series to the DC power source via the current resonant capacitor,
wherein the output characteristic is adjusted by the first capacitor, the second capacitor and the third capacitor.

6. A resonant converter comprising:
a first switching element and a second switching element, which are connected in series, and which are to be connected with a DC power source;
a series resonant circuit, which includes a current resonant reactor, a primary coil of a transformer, and a current resonant capacitor, and which is connected in parallel to one of the first switching element and the second switching element,
a rectifying-and-smoothing circuit, which is connected to a secondary coil of the transformer, wherein an output voltage generated from the rectifying-and-smoothing circuit is to be supplied to a load by ON-OFF control of the first switching element and the second switching element; and
a clamp circuit which clamps a voltage between both ends of the current resonant capacitor to a predetermined voltage value,
wherein, when an output current supplied from the rectifying-and-smoothing circuit to the load is higher than the predetermined current value, an output characteristic is set so that, as the output current is increased, the output voltage is decreased.
